(19) United States
(12) Patent Application Publication
(10) Pub. No.: US 2005/0092312 A1
(43) Pub. Date: May 5, 2005

(54) Indirect and direct heated continuous oven system

(76) Inventors: Ramesh M. Gunawardena, Chagrin Falls, OH (US); Michael Kish, Vinton, VA (US)

Correspondence Address: Kevin D. Erickson;Pauley Petersen & Erickson, Suite 365, 2800 West Higgins Road, Hoffman Estates, IL, 60195, US

(21) Appl. No.: 10/698,340

(22) Filed: Oct. 31, 2003

(51) Int. Cl. A21B 1/00

(52) U.S. Cl. 126/19 R

(57) ABSTRACT

A cooking oven system and related method for cooking a batch of food items having any number of potential substrate characteristics, e.g., beef, pork, chicken, etc., wherein an indirect cooking chamber having a high humidity is transitioned into a direct cooking chamber having a high temperature. A process control system connects the indirect cooking chamber with the direct cooking chamber to ensure proper operating conditions depending upon the substrate.

### BACKGROUND OF THE INVENTION

1. Field of the Invention

This invention relates to a indirect and direct heated continuous impingement oven system to deliver desired food attributes on substrates requiring different treatments.

2. Description of Prior Art

Cooking ovens for cooking food typically include a heat source, air mover and heat exchanger are typically provided within the cooking chamber for cooking the food provided on the conveyor. A uniform and consistent cooking environment for different food items, such as beef, pork and chicken, is difficult to maintain in existing cooking ovens because of a lack of proper operating conditions including air flow, moisture content, recirculation, heat exchange and other factors. As such, it is desirable that when beef, for example, is cooked in a cooking oven designed for chicken, the final cooked product achieves the desired taste, appearance, waste and/or safety characteristics.

In general, different substrates require very specific application treatments to deliver the sensory attributes desired by consumers. Food processors strive to deliver these specific home cooked food attributes through continuous large-scale industrial cooking systems. These systems have considerable flexibility in the preparation steps that lead to altering the flavor profile or adding value through coating and seasonings during the raw and partially cooked stages. However, heat treatment steps determine the final food item outcome in terms of product quality, flavoring, color development, and food safety.

### SUMMARY OF THE INVENTION

It is therefore an object of this invention to provide a cooking oven system that is capable of cooking a wide variety of food items having varying substrate characteristics.

It is one object of this invention to provide a cooking oven system that provides uniform and controllable cooking conditions.

It is one object of this invention to provide a cooking oven system having an adjustable cooking cycle that has flexibility to deliver proper conditions required for a given substrate.

It is another object of this invention to provide a cooking oven system having a combination of hardware and controls to deliver energy to the food item optimally and efficiently to produce food items at a lower cost per pound in relation to existing ovens.

It is yet another object of this invention to provide an indirect cooking chamber having a thermal fluid heat exchanger heating an air-vapor mixture within the indirect cooking chamber.

It is still another object of this invention to provide a direct cooking chamber having one or more gas-fired burners.

A cooking oven system according to a preferred embodiment of this invention includes an indirect cooking chamber cooking at a high humidity and a transition from the indirect cooking chamber and into a direct cooking chamber cooking at a high temperature, preferably using direct gas-fired burners.

In most cooking processes involving humidity, such as in the indirect cooking chamber of the present invention, there is a certain percentage of moisture that condenses on the surface of food items. The energy that is delivered to the surface during this process occurs through the change of phase in the steam. This energy subsequently migrates to the core of the food items through conduction. This translates to a corresponding increase in the internal core temperature of the food items. Of course, the thicker and/or dryer the food items, the longer it will take to reach a steady state core temperature which can be measured. Another key variable that influences the time constant is the composition of the substrate itself.

Therefore, the greater the amount of steam available for condensing, the larger the rise in the core temperature of a given food item. This generally holds true so long as the surface of the food item is below the dew point temperature of the surrounding atmosphere. Once the surface reaches the dew point temperature there is generally no energy delivered to the surface of the food item through condensation. At this point, depending on the temperature of the surrounding atmosphere, there is a possibility for food item surface cooling caused by evaporative cooling. In order to continue to drive energy to the surface, the heating mechanism should be changed to convection or high velocity impingement combined with higher temperature heating.

The above two parameters combined with high humidity can deliver better control of food item yield. The optimum mix of parameters for this step following condensation is dependent on the substrate and desired sensory attributes of the food item.

A preferred embodiment of the present invention involves a cooking oven system with an indirect heating chamber or zone and a direct heating chamber or zone. A transition is preferably positioned between the indirect heating chamber and the direct heating chamber to maintain correct operating conditions within the respective cooking zones. A process control system preferably links the indirect heating chamber with the direct heating chamber to provide optimum operating conditions depending upon the substrate characteristics of the food item.

The cooking oven system according to this invention may additionally include a transport mechanism, such as a conveyor, that extends entirely, or partially, through the indirect heating chamber, the transition and the direct heating chamber and between an inlet and an outlet of the cooking oven system. An air distribution system may be positioned in fluid communication with the indirect cooking chamber and the direct cooking chamber and may include one or more blowers or other devices for circulating conditioned air throughout the respective cooking chambers. The process control system may additionally control the transport mechanism, the air distribution system, steam flow, top and bottom air flow distribution and the heat transfer penetration rate.

### BRIEF DESCRIPTION OF THE DRAWINGS

The above-mentioned and other features and objects of this invention will be better understood from the following detailed description taken in conjunction with the drawings wherein:

FIG. 1 is a schematic view of a cooking oven system according to one preferred embodiment of this invention; and

FIG. 2 is a schematic view of a cooking oven system according to another preferred embodiment of this invention.

### DESCRIPTION OF PREFERRED EMBODIMENTS

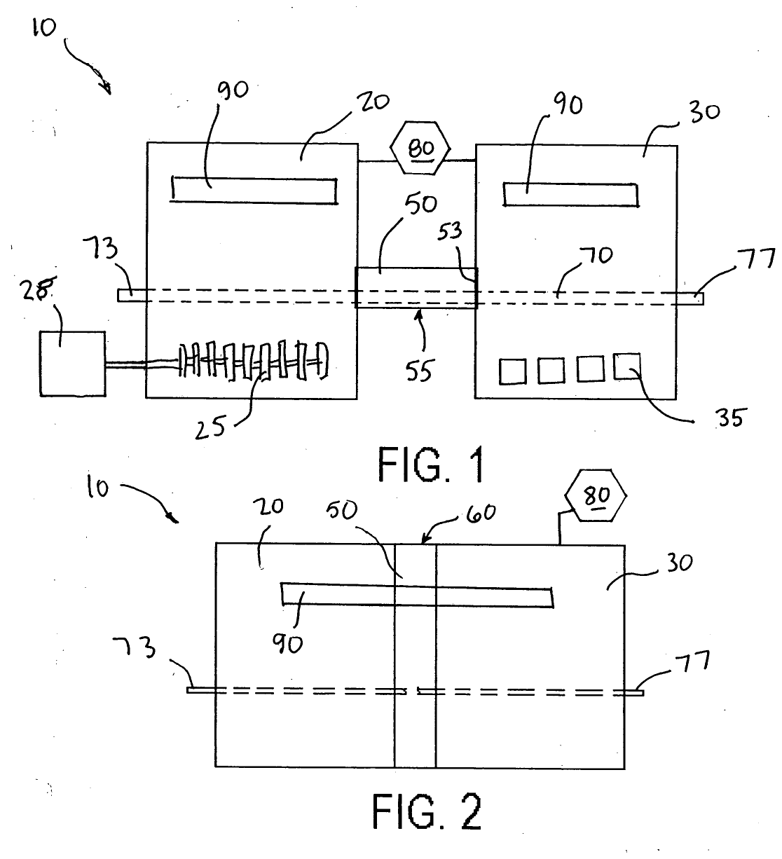

FIG. 1 shows a cooking oven system according to one preferred embodiment of this invention. Cooking oven system 10 is preferably a stand-alone or modular oven which may have any desired number of modules joined together in an end-to-end relationship. Cooking oven system 10 preferably includes indirect and direct heated continuous cooking chambers to deliver desired food attributes on substrates requiring different treatments.

Different substrates that are desirable for use in such cooking oven system 10 may include beef, pork, fish, bakery items and any other such item or combination requiring unique operating conditions to produce cooked food items having optimal attributes.

The current state of the art cooking systems lack flexibility in extracting the flavor profile and mouth feel that is unique to a given substrate. This is primarily due to the lack flexibility in the cooking system to deliver the precise conditions needed at the right time in the cooking process. Simply applying heat does not necessarily produce the desired home cooked attributes. Several interrelated factors typically bring about the desired flavor profile. For example, heat processing conditions, sequences and equipment needed for poultry, beef, pork and bakery items can vary significantly. Therefore, flexibility of heat treatments, the timely application of appropriate heat transfer mechanisms and overall equipment and system design are crucial to bringing about the qualities that are inherent and unique to the respective substrates. Furthermore, food item appeal and texture associated with coatings external to the substrate are also enhanced through precise control and conditioning of heat delivery.

The current invention describes the design and use of a non-dedicated system for multiple substrates that require different processing treatments. For example, this system can produce food items of different substrates such as beef, pork, fish, poultry and bakery items to deliver improved quality without having to re-arrange hardware for cooking. This involves a combination of an indirect and direct heated system with highest humidity heat conditioning upstream and dryer conditioning coupled with direct flame induced heat downstream respectively.

As shown in FIG. 1, and briefly described above, cooking oven system 10 preferably includes: (1) indirect cooking chamber 20 for cooking a continuous batch of food items in a high humidity; and (2) direct cooking chamber 30 for cooking the continuous batch of food items at a high temperature. As shown schematically in FIGS. 1 and 2, indirect cooking chamber 20 and direct cooking chamber 30 may comprise two separate “boxes” or alternatively comprise a single “box.” In each alternative, the distinct cooking chambers are preferably separated with transition 50.

The air-vapor mixture in indirect cooking chamber 20 is preferably heated using thermal fluid from a thermal fluid heat exchanger 25 located within indirect cooking chamber 20. The thermal fluid heat exchanger 25 may be heated externally with heater 28. Indirect cooking chamber 20 preferably operates at a temperature less than 450 degrees F. and at a moisture by volume greater than 80% and more preferably greater than 90% and more preferably at greater than 95%. The ability to maintain a higher moisture volume may be attributable, in one preferred embodiment of this invention, to the lack of combustion air in produced by thermal fluid heat exchanger 25. In addition, minimizing air infiltration into indirect cooking chamber 20 may result from improved containment. The humidity content of indirect cooking chamber 20 may be changed through the use of a moisture control device such as a Humitrol®, manufactured by FMC Technologies, Inc.

Direct cooking chamber 30 preferably includes one or more gas-fired burners 35. Direct cooking chamber 30 preferably operates at a temperature exceeding 400 degrees F. and more preferably exceeding 450 degrees F. and more preferably exceeding 500 degrees F. The direct flame induced heat during the final stages of the subject process thereby allows for achieving flavor profiles not possible with indirect only systems especially for food substrates having beef and pork origin. In addition, such a direct cooking chamber 30 having one or more gas-fired burners improves browning capability at lower operating cost over existing systems. Higher and dry processing capability at the final stages within cooking oven system also enhances food color development and flavor profile.

Transition 50 is preferably positioned between indirect cooking chamber 20 and direct cooking chamber 30. As shown schematically in FIG. 1, transition 50 may comprise tunnel 55, preferably approximately 2 feet in length that extends between indirect cooking chamber 20 and direct cooking chamber. Alternatively, as shown schematically in FIG. 2, transition 50 may comprise partition 60 that divides a unitary indirect cooking chamber 20 and direct cooking chamber 30. In each alternative, transition 50 preferably isolates indirect cooking chamber 20 from direct cooking chamber 30. Such isolation may be effected with at least one seal 53 positioned within transition 50 for isolating the operating conditions of indirect cooking chamber 20 from direct cooking chamber 30. Seal 53 may be a mechanical seal, a steam curtain or any means for isolating the operating conditions of the separate cooking chambers known to those having ordinary skill in the art.

Transition 50, in part, improves process safety of the operation, such as explosion protection. In addition, an independent transition 50 structure, such as tunnel 55, simplifies handling the overall stress distribution.

Each of indirect cooking chamber 20 and direct cooking chamber 30 may include an independent air distribution system 90 for controlling air flow within the respective chamber. Precise distribution and control of the top and bottom air flow in each cooking chamber delivers improved food item quality through more finite and regulated distribution. Preferably, air distribution system 90 is coupled with a heat exchanger and air manifolds are positioned in fluid communication with a respective chamber, particularly indirect cooking chamber 30 to produce, direct and recirculate air flow through indirect cooking chamber 30. Air distribution system 90 preferably includes one or more air plenums, fans, blowers and/or other devices for circulating conditioned air to air manifolds which upon impinging on food items returns through air distribution system 90. Air distribution system 90 may include a combination of forced draft air flow and induced air flow to generate proper and uniform conditions throughout cooking oven system 10.

As used in this specification and claims, air flow is defined as conditioned air, vapor, gas and/or fluid used to circulate through cooking oven system 10. According to one preferred embodiment of this invention particularly in reference to indirect cooking chamber 20, air flow comprises steam of varying temperatures and moisture content. As such, the energy is delivered predominantly through the condensation of a thermal fluid on the surface of a food item. This method of energy delivery allows for optimum control of the overall process resulting in increased food item throughput, yield and improved quality, especially during the indirect stage.

According to one preferred embodiment of this invention, process control system 80 is connected with indirect cooking chamber 20 and direct cooking chamber 30. Process control system 80 preferably maintains the desired operating conditions within indirect cooking chamber 20 and direct cooking chamber 30. According to a preferred embodiment of this invention, process control system 80 may selectably control the operating conditions within indirect cooking chamber 20 and/or direct cooking chamber 30 depending upon a particular substrate to be cooked. For example, the operating conditions, such as temperature, thermal fluid flow, humidity, air flow, top and bottom distribution of air and/or heat penetration rate may be adjusted depending upon whether the substrate comprises beef, pork, chicken, bakery items and/or any other desired substrate.

Process control system 80 thereby enables precise control of moisture conditioning in each chamber (zone) of cooking oven system 10 to pre-established conditions irrespective of changes in the external conditions or seasonal variations. Process control system 80 may additionally control steam flow, top and bottom air flow distribution and the heat transfer penetration rate within cooking oven system 10.

Transport mechanism 70, such as a conveyor, is preferably positioned at least partially, and preferably entirely, through indirect cooking chamber 20, transition 50 and direct cooking chamber 30. Transport mechanism 70 is used to transport food items through cooking oven system 10 and may include a single unitary belt or numerous transport segments or belts. Transport mechanism 70 is preferably a pervious belt thus permitting air and liquid to flow through.

In addition, cooking oven system 10 may further include infeed conveyor 73 connected to an inlet of indirect cooking chamber 20. Infeed conveyor 73 preferably supplies the uncooked substrate/food items to indirect cooking chamber 20 at a desired mass flow rate. Accordingly, outfeed conveyor 77 is preferably connected to an outlet of direct cooking chamber 30. Outfeed conveyor 77 preferably discharges fully cooked and/or pre-cooked substrate/food items from cooking oven system 10. The length and configuration of infeed conveyor 73 and outfeed conveyor 77 may be determined by food item throughput and quality requirements of the individual processor.

Transport mechanism 70 preferably includes controllable speed along at least a portion of its length. According to one preferred embodiment of this invention, process control system 80 may electronically control, or otherwise communicate with, transport mechanism 70.

According to a preferred embodiment of this invention, transport mechanism 70 operates continuously whenever cooking oven system 10 is in operation. Thus, cooking oven system 10 may be referred to as a continuous oven. Uncooked food items, preferably in batches, are loaded onto transport mechanism 70 continuously at an inlet of indirect cooking chamber 20 and transported through the respective chambers 20, 30 and preferably emerges treated and/or cooked, at an outlet of direct cooking chamber 30 of cooking oven system 10.

Accordingly, a method of cooking a batch of food items within cooking oven system 10 includes the steps of moving the batch of food items through indirect cooking chamber 20 operating at a high humidity; moving the batch of food items through transition 50 at an outlet of indirect cooking chamber 20; and moving the batch of food items through direct cooking chamber 30 operating at a high temperature. Operating conditions, including temperature, humidity and air flow, are continuously maintained in indirect cooking chamber 20 and direct cooking chamber 30 based upon the substrate characteristics of the food items using process control system 80 connected with the respective cooking chambers. Additional conditions such as speed of transport mechanism 70 and the effectiveness of transition 50 may further be controlled using process control system 80. In addition, process control system 80 may adjustment the heat penetration rate into the food-items by varying the distance of jets, burners and/or other heating means to the food items

Finally, a substrate characteristic of the food item to be processed may be entered into process control system 80 which may then responsively adjust the humidity content of indirect cooking chamber 20 and/or the temperature of direct cooking chamber 30 and/or the top and bottom airflow to obtain the desired surface characteristics.

The resulting apparatus and method thereby permits improved latitude to optimize throughput, yield and flavor and/or other sensory properties. For instance, the precise conditioning capability afforded by process control system 80 allows minimizing damage to the food casing during processing of sausage. Also, distinct processing zones enable very specific sensory attributes on dough based bakery items.

In addition, a single system (and sequence of processing steps) according to a preferred embodiment of this invention arranged to produce food items of different substrates delivers improved quality without the need to rearrange, reconfigure or replace hardware for cooking. Avoidance of such changes in hardware results in improved overall process economics and lower initial cost. Such economics are further benefitted by the improved food item throughput relative to a direct gas only and improved yield relative to an indirect heated only process. Such improved food item throughput results in lower emissions and substrate rendering waste.

While in the foregoing specification this invention has been described in relation to certain preferred embodiments thereof, and many details have been set forth for purpose of illustration, it will be apparent to those skilled in the art that this invention is susceptible to additional embodiments and that certain of the details described herein can be varied considerably without departing from the basic principles of the invention.

1. A cooking oven system comprising:
an indirect cooking chamber for cooking a batch of food items in a high humidity;
a direct cooking chamber for cooking the batch of food items at a high temperature, the direct cooking chamber including one or more gas-fired burners;
a transition positioned between the indirect cooking chamber and the direct cooking chamber; and
a process control system connecting the indirect cooking chamber with the direct cooking chamber and maintaining desired operating conditions within the indirect cooking chamber and the direct cooking chamber.

2. The cooking oven system of claim 1 wherein the transition comprises a partition isolating the indirect cooking chamber from the direct cooking chamber.

3. The cooking oven system of claim 1 wherein the transition comprises a tunnel extending between the indirect cooking chamber and the direct cooking chamber.

4. The cooking oven system of claim 1 further comprising:
an infeed conveyor connected to the indirect cooking chamber; and
an outfeed conveyor connected to the direct cooking chamber.

5. The cooking oven system of claim 1 further comprising:
a transport mechanism extending from an inlet of the indirect cooking chamber through the transition and to an outlet of the direct cooking chamber, the transport mechanism for moving the batch of food items through the cooking chamber.

6. The cooking oven system of claim 5 wherein the process control system is additionally in communication with the transport mechanism.

7. The cooking oven system of claim 1 wherein the process control system selectably controls the operating conditions within the indirect cooking chamber and the direct cooking chamber depending upon a substrate of the food items.

8. The cooking oven system of claim 7 wherein the substrate is at least one of beef, pork, chicken and bakery items.

9. The cooking oven system of claim 1 further comprising:
at least one seal positioned within the transition for isolating the operating conditions of the indirect cooking chamber from the direct cooking chamber.

10. A method of cooking a batch of food items within a cooking oven system comprising the steps of:
moving the batch of food items through an indirect cooking chamber operating at a high humidity;
moving the batch of food items through a transition at an outlet of the indirect cooking chamber;
moving the batch of food items through a direct cooking chamber operating at a high temperature;
maintaining the operating conditions of the indirect cooking chamber and the direct cooking chamber based upon the characteristics of the food items using a process control system connecting the indirect cooking chamber with the direct cooking chamber.

11. The method of claim 10 wherein the operating conditions are adjusted by controlling a speed that the batch of food items travels through the cooking chamber.

12. The method of claim 10 further comprising:
adjusting an air flow in the indirect cooking chamber and the direct cooking chamber using the process control system.

13. The method of claim 10 further comprising:
determining a substrate characteristic of the food items to be processed;
responsively adjusting the humidity of the indirect cooking chamber and the temperature of the direct cooking chamber using the process control system.

14. The method of claim 10 wherein the moisture by volume within the indirect cooking chamber is greater than 95%.

15. The method of claim 10 wherein the temperature within the direct cooking chamber is greater than 500 degrees F.

16. The method of claim 10 further comprising:
extending a transport mechanism through the indirect cooking chamber and the direct cooking chamber for moving the batch of food items through the cooking oven system.

17. The method of claim 16 further comprising:
adjusting a speed of the transport mechanism using the process control system.

18. The method of claim 16 further comprising:
isolating an operating condition of the indirect cooking chamber from an operating condition of the direct cooking chamber using the transition between the indirect cooking chamber and the direct cooking chamber.

19. A cooking oven system comprising:
an indirect cooking chamber for cooking a batch of food items;
a thermal fluid heat exchanger positioned within the indirect cooking chamber;
a direct cooking chamber for cooking the batch of food items;
one or more gas-fired burners positioned within the direct cooking chamber;
a tunnel positioned between the indirect cooking chamber and the direct cooking chamber; and
a process control system connecting the indirect cooking chamber with the direct cooking chamber and maintaining desired operating conditions within the indirect cooking chamber and the direct cooking chamber.

20. The cooking oven system of claim 19 further comprising:
a single transport mechanism extending through the indirect cooking chamber, the tunnel and the direct cooking chamber.
